(19) United States
(12) Patent Application Publication
(10) Pub. No.: US 2014/0118915 A1
(43) Pub. Date: May 1, 2014

(54) Computing Devices

(71) Applicant: EMERGING TECHNOLOGY (HOLDINGS) LTD., Kwun Tong (CN)

(72) Inventors: Stephen Albert Dukker, San Francisco, CA (US); Martin Shnitzer, San Francisco, CA (US); Martin Kay, San Francisco, CA (US); Anthony Patron, Mountain View, CA (US); Adam Mekeel Mack, Menlo Park, CA (US); Youenn Colim, Sam Francisco, CA (US); Avi Geiger, Seattle, WA (US)

(73) Assignee: Emerging Technology (Holdings) Ltd., Kwun Tong (CN)

(21) Appl. No.: 13/665,785

(22) Filed: Oct. 31, 2012

(51) Int. Cl. G06F 1/16

(52) U.S. Cl. CPC G06F 1/1681
USPC 361/679.09; 361/679.26; 361/679.27

(57) ABSTRACT

In one embodiment, a computer device comprises a back cover in the shape of a plate and a basic module where the back cover is removably attachable to and detachable from a basic module of the computing device by the user by an attachment portion. In this manner designs of and on the back cover may be easily customized to the individual tastes of consumers. Another embodiment of the invention is directed to the back cover and the attachment portion of the type described above. An optional front cover may be added and connected to the back cover about a hinge. The front cover can serve as a stand for the computer display when rotated about the hinge away from the display screen. The optional front cover may also be connected to the back cover by a side cover to form a device resembling a hard bound book.

### BACKGROUND OF THE INVENTION

This invention relates in general to computing devices and in particular to computing devices with detachable back covers.

Portable computing devices are used by consumers for many different functions, such as word processing, spreadsheets, managing photographs and videos, emails and for accessing the internet. Most designs for such computing devices, however, are not personalized for the tastes of the individual consumer. As a result, from the appearance of the devices alone, it is difficult to distinguish between the devices used by different individuals. It is therefore desirable to provide portable computing devices that are designed to be personalized to the tastes of each individual consumer.

Tablet computers have been very popular with consumers. However, in its present form, tablet computers are not the most convenient for users. It is therefore desirable to provide tablet computers that are more user friendly and convenient.

### SUMMARY OF THE INVENTION

One embodiment of the invention is a computer device comprising a back cover preferably in the shape of a plate and a basic module comprising a circuit performing one or more computing operations, a front side with a display panel with at least one dimension exceeding 7 inches for displaying images visible to a user in response to said computing operations, and a back side adapted to be connected to the back cover. The computer device further includes an attachment portion configured to enable the back cover to be removably attachable to and detachable from the basic module of the computing device by the user, so that when the back side is connected to the back cover by means of said attachment portion, a complete computing device is formed that is substantially in the shape of a square or rectangular plate.

Another embodiment of the invention is directed to the back cover and the attachment portion of the type described above.

Yet another embodiment of the invention is directed to a housing cover for a computing device comprising a back cover preferably in the shape of a plate and a front cover in the shape of a plate mechanically connected to the back cover about a hinge. The housing cover farther includes an attachment portion configured to enable the back cover to be removably attachable to and detachable from a basic module of the computing device by a user, said basic module comprising a circuit performing one or more computing operations, a front side with a display panel with at least one dimension exceeding 7 inches for displaying images visible to the user in response to said computing operations, and a back side adapted to be connected to the back cover by means of said attachment portion, so that when the back side is connected to the back cover by means of said attachment portion, a complete computing device is formed, said front cover being rotatable about said hinge so that when the front cover is rotated towards the basic module to cover the display panel, the computing device is substantially in the shape of a square or rectangular plate.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIGS. 1A and 1B are front and rear views of a tablet computer to illustrate one embodiment of the invention.

FIGS. 2A-2E are schematic views of the interchangeable back covers of a tablet computer to illustrate the embodiment of the invention in FIG. 1.

FIG. 3A is an exploded view of the different parts of a tablet computer to illustrate another embodiment of the invention.

FIG. 3B is a schematic view of some of the parts of the tablet computer in FIG. 3A to illustrate the embodiment of FIG. 3A.

FIGS. 4A and 4B are perspective views a tablet computer, where FIG. 4A illustrates the tablet computer in a closed position and FIG. 4B illustrates the same tablet computer in an open position to illustrate still another embodiment of the invention.

FIG. 5 is a perspective view of a tablet computer in an open position to illustrate yet another embodiment of the invention.

FIGS. 6A and 6B are perspective views a tablet computer, where FIG. 6A illustrates the tablet computer in an open position and FIG. 6B illustrates the same tablet computer in a closed position to illustrate an additional embodiment of the invention.

FIGS. 7A and 7B are perspective views a tablet computer, where FIG. 7A illustrates the tablet computer in a closed position and. FIG. 7B illustrates the same tablet computer in an open position to illustrate one more embodiment of the invention.

FIG. 8A is an exploded view of the different parts of a tablet computer to illustrate an alternative embodiment of the invention to that in FIG. 3A.

FIG. 8B is a block diagram to illustrate the functions of some of the components in the back cover of the tablet computer in FIG. 8A to illustrate the embodiment of FIG. 8A.

FIG. 8C is a schematic view of some of the parts of the tablet computer in FIG. 8A to illustrate the embodiment of FIG. 8A.

For simplicity in description, identical parts or components are labeled by the same numerals in the figures of this document.

### DETAILED DESCRIPTION OF EXEMPLARY EMBODIMENTS

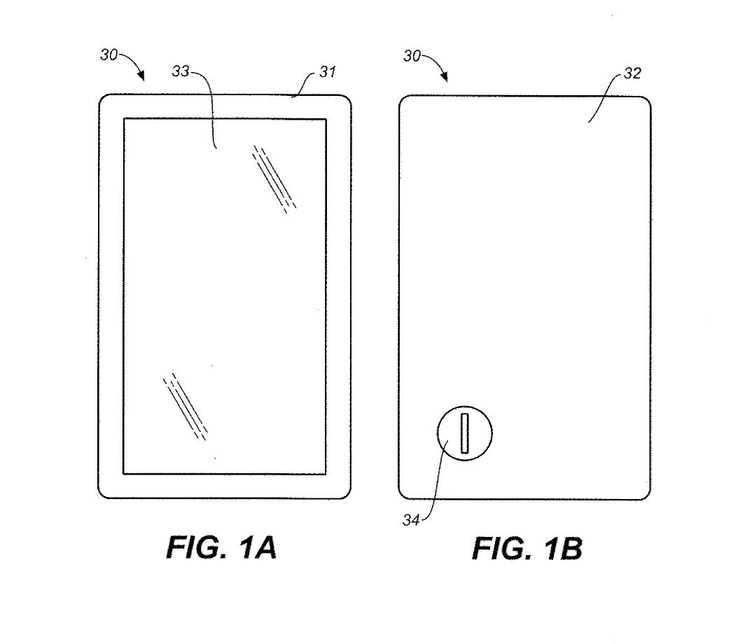

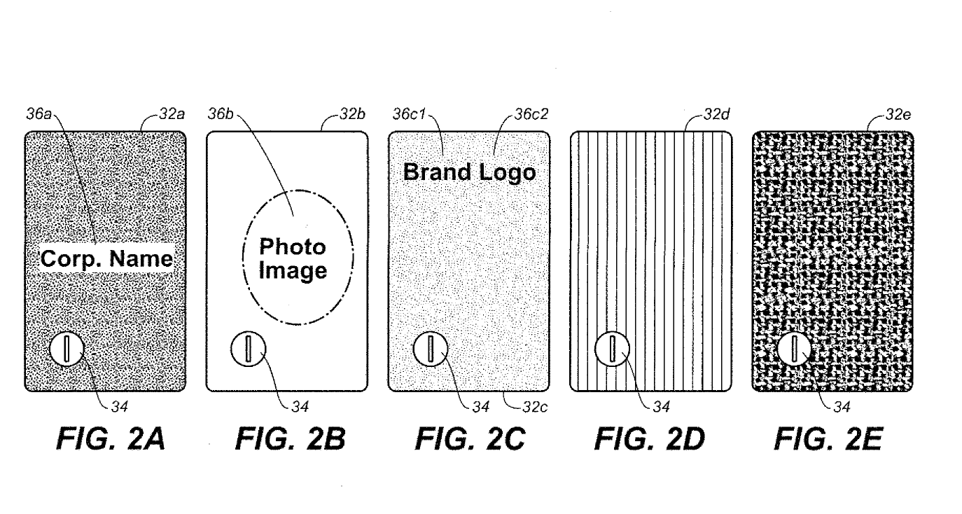

FIGS. 1A and 1B are front and rear views respectively of a tablet computer to illustrate one embodiment of the invention. The front side of computer 30 includes a bezel 31 which holds in place a cover glass plate 33, through which users may view a display of computer 30. The glass plate 33 may also be held without bezel 31 by a different mechanism so that the front side of the computer 30 has a flush surface. The back side of computer 30 includes a back cover 32, which is attached to the chassis (not shown) of computer 30 by attachment portion or means such as a quarter turn locking mechanism 34. This arrangement makes it easy for consumers to remove the back cover of computer 30 and install another alternative back cover amongst a plurality of back covers. This feature enables the user to personalize the tablet computer as illustrated by the back covers in FIGS. 2A-2E. The quarter turn locking mechanism 34 may be spring loaded, and locking is accomplished by turning the mechanism (such as by means of a coin) by about 90 degrees while pushing against the spring until a latch locks the back cover in position. Unlocking is accomplished by turning in the opposite direction by a quarter turn. Such quarter turn locking mechanisms are known to those skilled in the art and need not be disclosed herein in detail.

FIGS. 2A-2E are schematic views of the interchangeable custom back covers of a tablet computer 30 to illustrate the embodiment of the invention in FIG. 1. When used in a corporate environment, the back cover 32a used in computer 30 may show the corporate name 36a on it as shown in FIG. 2A. This design enables a business to customize their computers used by all employees. As an alternative, the back cover 32b may show a picture, such as that of the user's daughter 36b on it as shown in FIG. 2B. This picture may be uploaded to a service that creates an imprint of the picture on the back cover. As another alternative, the back cover 32c may show a brand name 36c1 together with a logo 36c2 on it as shown in FIG. 2C, where the brand name and logo are imprinted onto the back cover 32c. As yet other alternatives, desired and personalized designs of the type shown in FIGS. 2D and 2E may be imprinted onto the respective back covers 32d and 32e as shown. As shown in FIGS. 2A-2E, each of the back covers 32a-32e is attached to the chassis or another part or frame (not shown) of computer 30 by means of locking mechanism 34.

The back covers 32a through 32e are interchangeable custom back covers of a tablet computer 30. Depending on the occasion, a different back cover may be used by the consumer. When used in the work place, for example, the customer may use the back cover 32a. However, when used at home, the customer may remove back cover 32a by unlocking locking mechanism 34 and replace back cover 32a with back cover 32b with his or her daughter's picture thereon, by attaching it to the rest of the computer using locking mechanism 34. Back cover 32c may be used instead by replacing another back cover is the manner described above when targeting a specific brand and logo. This may be useful when the customer is starting a business using certain brands and logos. As yet other alternatives, back covers such as 32d or 32e may be used to match the attire of the customer or simply according to personal preferences or tastes. Each of these back covers may be attached to or detached from the rest of the computer 30 using locking mechanism 34 at a location of the back cover that is away from all edges of the back cover.

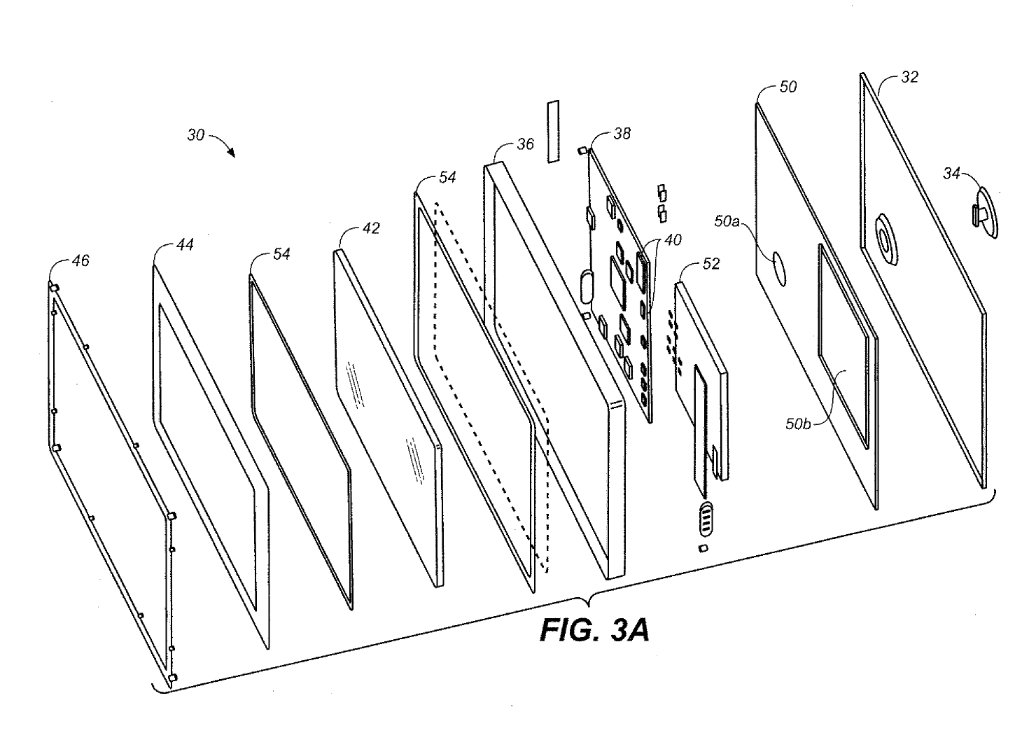

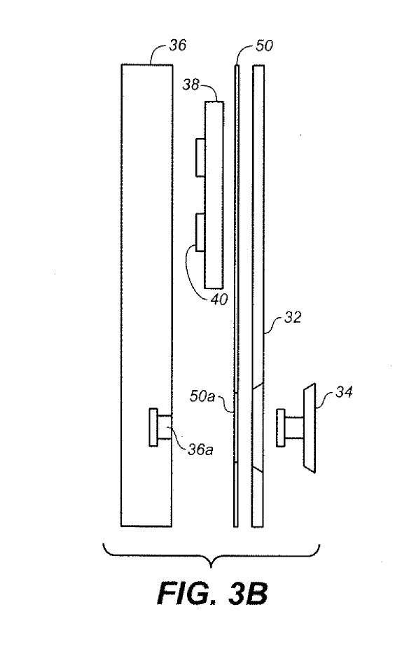

FIG. 3A is an exploded view of the different parts of tablet computer 30 to illustrate another embodiment of the invention. FIG. 3B is a partly schematic and partly cross-sectional view of some of the parts of the tablet computer in FIG. 3A to illustrate the embodiment of FIG. 3A. Computer 30 includes a back cover 32, locking mechanism 34 and chassis 36. Chassis 36 has a hole 36a (not shown in FIG. 3A but shown in FIG. 3B) therein with features such as a latch (not shown) at or near the hole surface that cooperate with locking mechanism 34 for locking the back cover to the chassis, and for unlocking the back cover from the chassis. Locking mechanism 34 may be used to attach the back cover 32 to chassis 36 by inserting mechanism 34 into the hole and making a quarter turn so that the mechanism 34 is locked onto the chassis by means of features such as the latch. To remove the back cover 32, locking mechanism 34 is unlocked from the hole in chassis 36 by making a quarter turn in a direction opposite to that for locking. A printed circuit hoard 38 with electronic circuits and components 40 attached thereon may be attached to chassis 36. Electronic circuits and components 40 such as one or more microprocessors and other circuitry perform the computing operations of the computer 30. A front side of computer 30 includes a liquid crystal display 42, cover glass 44 and preferably also bezel 46. The front side of the computer 30, the chassis 36, and the printed circuit board 38 with electronic circuits and components 40 attached thereon form a basic module of computer 30.

Preferably a protective sheet 50 is employed that covers the printed circuit board 38 with electronic circuits and components 40 and the side of chassis that faces the back cover. Thus, when the back cover 32 is removed from computer 30 by unlocking locking mechanism 34 as described above, the printed circuit board 38 with electronic circuits and components 40 will be protected from the environment and accidental damage by the protective sheet 50. Protective sheet 50 has a hole 50a therein through which the locking mechanism 34 passes for attachment to the chassis 36. An optional battery 52 may be included as part of the basic module of computer as well, which battery may be replaced through a removable section 50b of sheet 50. Additional optional bezels 54 may be employed between the chassis, liquid crystal display 42 and cover glass 44.

The front side of the computer 30 has at least one dimension, such as a diagonal of the front side, that exceeds 7 inches. This will enable a display screen of larger size to be employed at the front side of computer 30 for better viewing by consumers. As illustrated in FIGS. 1A, 1B, 2A-2E and 3A, 3B, computer 30 when fully assembled from the parts of FIG. 3A are substantially in the shape of a square or rectangular plate, which may or may not be of uniform thickness. In other words, the plate shape may or may not be totally flat. In some embodiments, it may be preferable for the plate to have chamfered, or beveled edges.

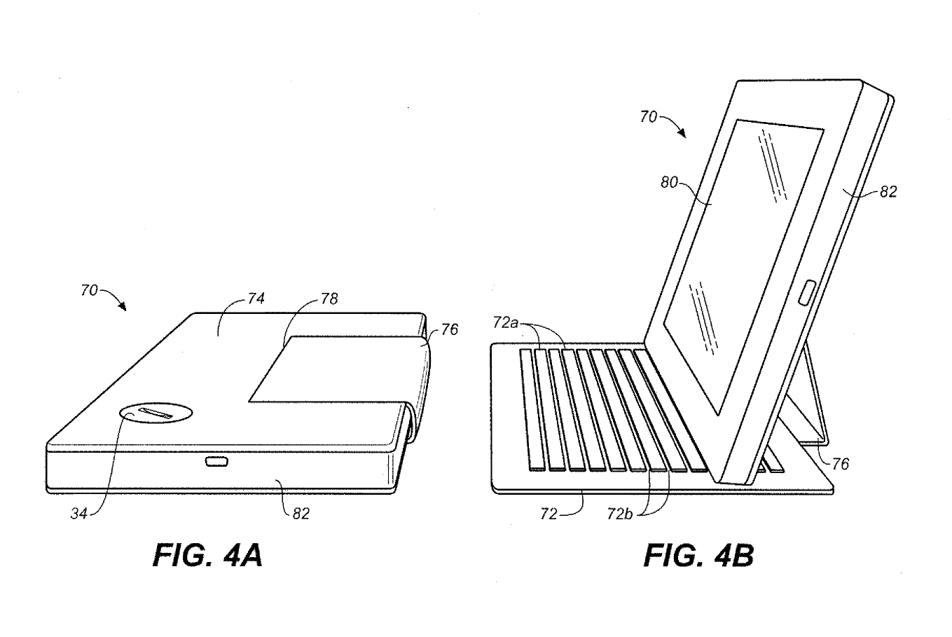

FIGS. 4A and 4B are perspective views of a tablet computer 70, where FIG. 4A illustrates the tablet computer in a closed position and FIG. 4B illustrates the same tablet computer in an open position with display screen visible to illustrate still another embodiment of the invention. As illustrated in FIGS. 1A, 1B, 3, 4A and 4B, tablet computer 70 differs from computer 30 in that it has a front cover 72 which is not present in computer 30. Front cover 72 is attached to back cover 74 about two hinge 76 and 78, and back cover 74 is also attached to the rest of the computer 70, such as to a chassis (not shown) in the manner shown in FIG. 3A for computer 30, by means of locking mechanism 34. Other than this difference, the basic module 82 of computer 70 may be the same as the basic module of FIG. 3A described above.

By setting the computer 70 in a face down position as shown in FIG. 4A with the front cover 72 in a horizontal position, and rotating the basic module 82 including display screen 80 of computer 70, together with back cover 74, about hinges 76 and 78, the display screen 80 and the basic module will be in an upright position and the display screen become visible as shown in FIG. 4B. The inside surface of front cover 72 has ridges 72a thereon, which define valleys 72b between the ridges. The valleys 72b define positions where the bottom edge of the display screen 80 and basic module 82 of the computer 70 may rest and be supported and held, for adjusting the substantially upright viewing position of the display screen at different angles to a vertical plane. The front cover 72 then serves as a stand for the basic module 82. The hinge 78 is connected to the back cover 74 at a location of the back cover that is away from all edges of the back cover. To close the computer 70, the back cover 74 together with basic module 82 including display screen 80 are rotated towards the front cover 72 until the front side of the basic module 82 faces and is protected by the front cover, in the position shown in FIG. 4A.

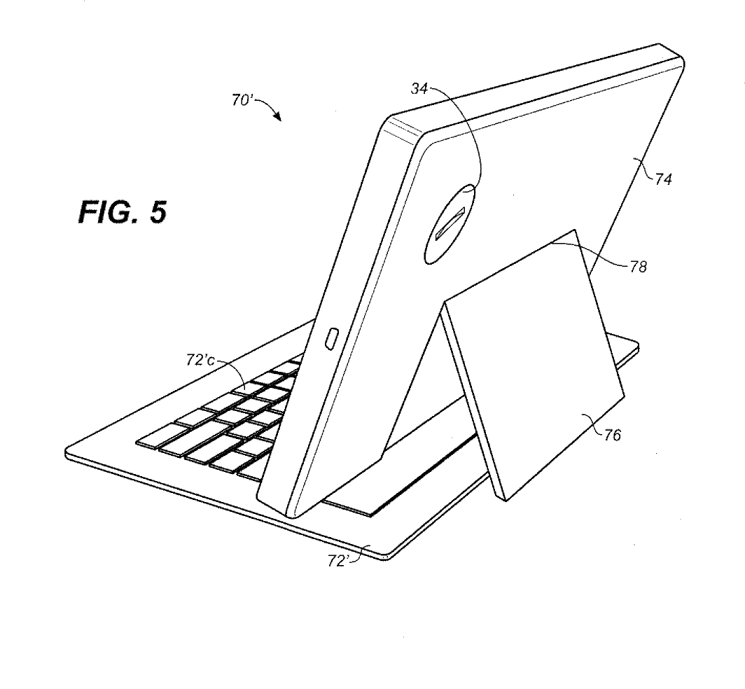

FIG. 5 is a perspective view of a tablet computer 70′ in an open position to illustrate yet another embodiment of the invention. Tablet computer 70′ differs from computer 70 of FIGS. 4A and 4B in that the inside surface of the front cover 72′ also has a keyboard 72′c thereon to enable users to input information to the computer for inputting information and for controlling desired computer operations. As in FIG. 4B, the inside surface of the front cover 72′ also has ridges and valleys (not shown) between the ridges. The valleys define positions where the bottom edge of the basic module of the computer 70′ may rest and be supported and held, for adjusting the substantially upright viewing position of the display screen.

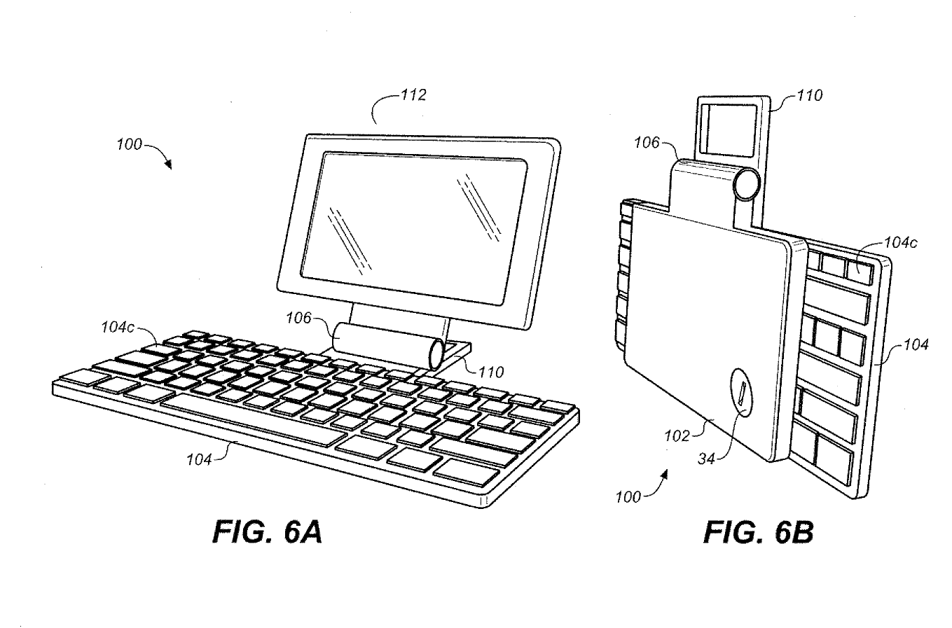

FIGS. 6A and 6B are perspective views of a tablet computer 100, where FIG. 6A illustrates the tablet computer in an open position and FIG. 6B illustrates the same tablet computer in a closed position to illustrate an additional embodiment of the invention. Computer 100 differs from computer 70′ of FIG. 5 in that the front cover 104 with keyboard 104c thereon is connected to the back cover 102 at a hinge 106 that is near an edge of the back cover, and not at a location away from all edges of the back cover as in FIG. 5. In an alternative embodiment, hinge 106 may be located at an edge of the back cover 102. Computer 100 also differs from computers 70 and 70′ of FIGS. 4A, 4B and 5 in that the front cover 104 is connected to the back cover 102 by only a single hinge 106 instead of two hinges 76 and 78 in computers 70 and 70′. Thus, the back cover 102 together with basic module 112 of computer 100 may be supported in a substantially upright position by friction at the hinge 106, and by front cover 104 and handle 110, and requires no valleys such as valleys 72b of FIG. 4B for holding and supporting basic module 112. As shown in FIG. 6B handle 110 allows computer 100 to be easily carried in one hand.

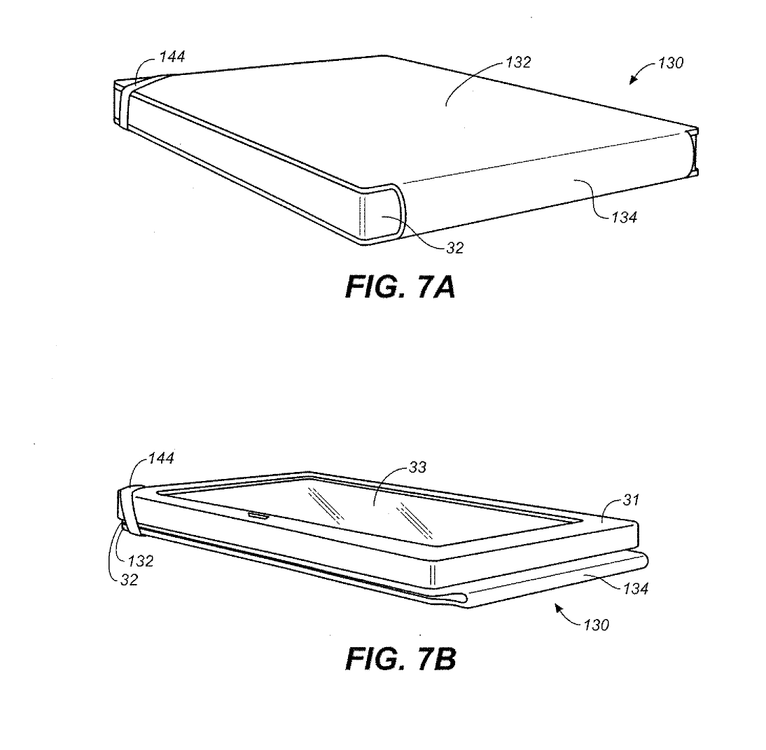

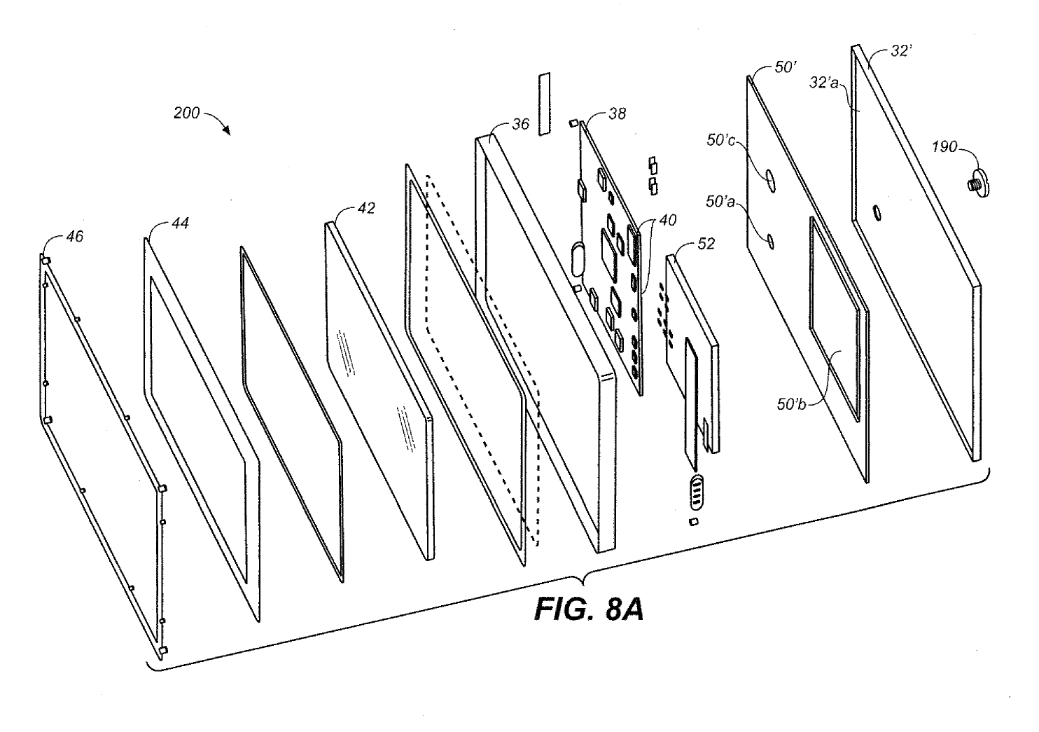

FIGS. 7A and 7B are perspective views a tablet computer 130, where FIG. 7A illustrates the tablet computer in a closed position and FIG. 7B illustrates the same tablet computer in an open position to illustrate one more embodiment of the invention. As shown in FIG. 7B, computer 130 includes a front side that has a bezel 31 and cover glass plate 33 for a display screen, back cover 32 and front cover 132. Back cover 32 and front cover 132 are connected together by a strip 134 of flexible material that functions as a side cover of computer 130. In the closed position shown in FIG. 7A, front cover 132 covers the bezel 31 and cover glass plate 33. To open the computer 130, front cover 132 is rotated about the strip 134 away from the cover glass plate 33 until it contacts the back cover 32, in a position as shown in FIG. 7B. Computer 130 of FIGS. 7A and 7B thus resembles a hard cover book in appearance and in the way it is opened and closed. An elastic band 144 anchored to the back cover 32 may be used to hold the front cover in the respective open or closed positions of computer 130.

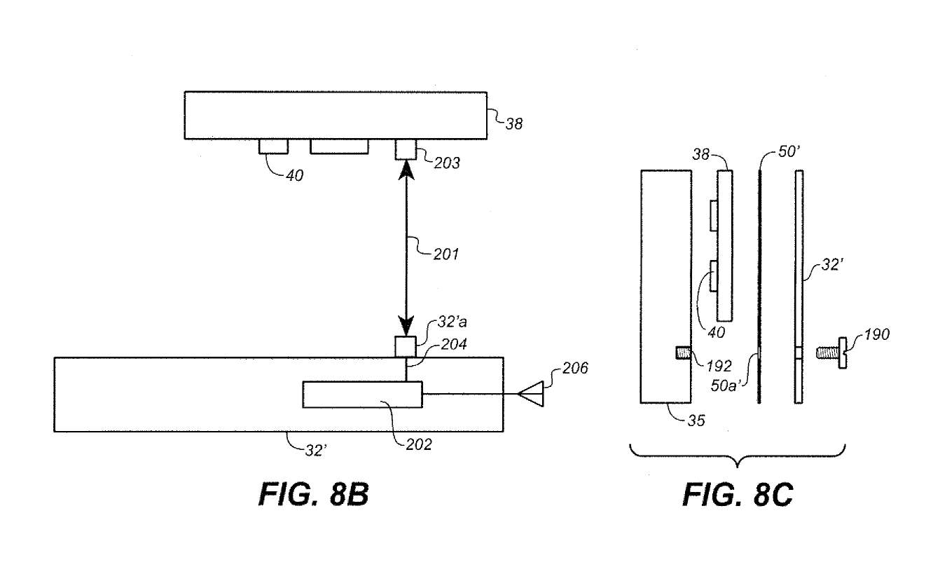

FIG. 8A is an exploded view of the different parts of a tablet computer 200 to illustrate an alternative embodiment of the invention to that in FIG. 3A. In this embodiment, back cover 32′ includes one or more electrical components 202 (not shown in FIG. 8A) that supply power to or cooperate with the electronic circuits and components 40 on printed circuit board 38 to perform computing and other desired functions performed by computers. The one or more electrical components in back cover 32′ may include for example, a battery, a wireless transceiver, a charging circuit for charging battery 52 in the basic module, or a controller that controls one or more of operation of the electronic circuits and components 40 on printed circuit board 38.

To connect the one or more electrical components in back cover 32′ to the electronic circuits and components 40 on printed circuit board 38, an electrical connector 32′a shown in FIG. 8A is used for connection to a matching connector 203 (not shown in FIG. 8A, but shown in FIG. 8B) on the printed circuit board 38. This connector 32′a passes through a hole 50′c in protective sheet 50′ to reach the matching connector 203 on the printed circuit board 38. FIG. 8C is a schematic view of some of the parts of the tablet computer 200 in FIG. 8A to illustrate the embodiment of FIG. 8A. As shown in FIG. 8C, protective sheet 50′ also has a hole 50′a for passage of a locking mechanism comprising a screw 190 for insertion into hole 192 in chassis 35 and attachment to matching grooves of the hole 192 in the chassis 35 when the screw is rotated into the hole, and a removable section 50′b through which battery 52 may be replaced. Where back cover 32′ includes a battery, this battery may be a backup battery to battery 52 in the basic module. The screw 190 and hole 192 with matching grooves locking mechanism may also be used in the embodiment of FIG. 3 instead of the quarter turn locking mechanism 34. Also, instead of the screw 190 and hole 192 with matching grooves locking mechanism, computer 200 of FIG. 8A may employ instead the quarter turn locking mechanism 34 of FIG. 3B.

FIG. 8B is a block diagram to illustrate the functions of some of the components in the back cover of the tablet computer in FIG. 8A to illustrate the embodiment of FIG. 8A. As shown in FIG. 8B, connector 32′a of back cover 32′ is electrically connected to connector 203 of printed circuit board 38 along arrow 201, where connectors 32′a and 203 may be a male/female connector pair known to those skilled in the art. Electrical connections such as metal lines (not shown in FIG. 8B) connect connector 203 to the electronic circuits and components 40 on printed circuit board 38. Connector 32′a of back cover 32′ is in turn electrically connected to the one or more electrical components 202 in back cover 32′ by connector 204. In this manner the one or more electrical components 202 in back cover 32′ may be used to supply power, or cooperate with the electronic circuits and components 40 on printed circuit board 38 to perform computer operations. Where the one or more electrical components 202 includes a wireless transceiver, this transceiver also is equipped with an antennae 206 shown in FIG. 8B.

While the invention has been described above by reference to various embodiments, it will be understood that changes and modifications may be made without departing from the scope of the invention, which is to be defined only by the appended claims and their equivalents. For example, while the back cover is preferably in the shape of a plate, back covers of other shapes may also be used, such as ones with more complex contours or curves on the corners and around the back. Other fastening devices such as clips or snaps may be used in addition to the locking mechanisms 34 or screw 190 for locking (and unlocking) the back cover to the basic module of computer 30.

1. A housing back cover for a computing device, the housing back cover comprising:
a back cover in the shape of a plate;
an attachment portion configured to enable the back cover to be removably attachable to and detachable from a basic module of the computing device by a user, said basic module comprising a circuit performing one or more computing operations, a front side with a display panel with at least one dimension exceeding 7 inches for displaying images visible to the user in response to said computing operations, and a back side adapted to be connected to the back cover by means of said attachment portion, so that when the back side is connected to the back cover by means of said attachment portion, a complete computing device is formed that is substantially in the shape of a square or rectangular plate.

2. The housing back cover of claim 1, further comprising an electronic component such that when the back cover is attached to the basic module, the electronic component is connected electrically with the circuit of the basic module to enable operation of the basic module or a mode of operation of the basic module.

3. The housing back cover of claim 2, said electronic component comprising a battery, a wireless transceiver a charging circuit for charging a battery in the basic module, or a controller that controls said mode of operation.

4. The housing back cover of claim 1, said attachment portion attaching the back cover to the basic module at a location away from all edges of the back cover.

5. A computer device comprising:
a back cover in the shape of a plate;
a basic module comprising a circuit performing one or more computing operations, a front side with a display panel with at least one dimension exceeding 7 inches for displaying images visible to a user in response to said computing operations, and a back side adapted to be connected to the back cover; and
an attachment portion configured to enable the back cover to be removably attachable to and detachable from the basic module of the computing device by the user, so that when the back side is connected to the back cover by means of said attachment portion, a complete computing device is formed that is substantially in the shape of a square or rectangular plate.

6. The computer device cover of claim 5, said back cover further comprising an electronic component such that when the back cover is attached to the basic module, the electronic component is connected electrically with the circuit of the basic module to enable operation of the basic module or a mode of operation of the basic module.

7. The computer device of claim 6, said electronic component comprising a battery, a wireless transceiver, a charging circuit for charging a battery in the basic module, or a controller that controls said mode of operation.

8. The computer device of claim 5, said attachment portion attaching the back cover to the basic module at a location away from all edges of the back cover.

9. The computer device of claim 5, further comprising a protective sheet that covers the back side of the basic module and that shields the circuit from ambient environment when the back cover is detached from the basic module.

10. The computer device of claim 5, further comprising a front cover for covering said display panel, said front cover mechanically connected and supported by said back cover, said front cover being movable away from the basic module in an open position to expose the display panel for viewing by the user.

11. The computer device of claim 10, said front cover connected to the back cover by a side cover, so that when the front cover is rotated to a closed position to cover said display panel, the computer device resembles a hard cover book in shape.

12. The computer device of claim 10, said front cover connected to the back cover by at least one mechanical hinge located away from all edges of the back cover and rotatably about said at least one mechanical hinge, so that when the front cover is in a horizontal position and the basic module rotated about said at least one mechanical hinge away from the front cover to an open position, the display panel is supported by the front cover wherein the front cover serves as a stand for holding the basic module with the display panel in an upright position.

13. The computer device of claim 12, said front cover having a surface that faces said display panel and that has ridges thereon, said ridges separated by valleys that define positions for holding an edge of the basic module, to enable the display panel to be set at different upright positions at different angles to a vertical plane.

14. The computer device of claim 12, said front cover having a surface that faces said display panel and that has a keyboard thereon, so that when the basic module is rotated about said at least one mechanical hinge away from the front cover to an open position and the front cover is in a horizontal position, the display panel is supported by the front cover and the keyboard is exposed and becomes available to the user for performing input functions.

15. The computer device of claim 14, said surface of the front cover that faces said display panel has a ridge thereon that define a position for holding an edge of the basic module, to enable the display panel to be set at an upright position.

16. The computer device of claim 10, said front cover connected to the back cover rotatably about at least one mechanical hinge located at or near an edge of the back cover, so that when the front cover is rotated about said at least one mechanical hinge away from the display panel and the front cover is in a horizontal position, the display panel in an upright position.

17. The computer device of claim 16, said front cover having a surface that faces said display panel and that has a keyboard thereon, so that when the basic module is rotated about said at least one mechanical hinge away from the front cover to an open position and the front cover is in a horizontal position, the display panel is supported by said at least one mechanical hinge and the front cover and the keyboard is exposed and becomes available to the user for performing input functions.

18. A housing cover for a computing device, comprising:
a back cover in the shape of a plate;
a front cover in the shape of a plate mechanically connected to the back cover about at least one hinge; and
an attachment portion configured to enable the back cover to be removably attachable to and detachable from a basic module of the computing device by a user, said basic module comprising a circuit performing one or more computing operations, a front side with a display panel with at least one dimension exceeding 7 inches for displaying images visible to the user in response to said computing operations, and a back side adapted to be connected to the back cover by means of said attachment portion, so that when the back side is connected to the back cover by means of said attachment portion, a complete computing device is formed, said front cover being rotatable about said at least one hinge so that when the front cover is rotated towards the basic module to cover the display panel, the computing device is substantially in the shape of a square or rectangular plate.

19. The housing cover of claim 18, further comprising an electronic component such that when the back cover is attached to the basic module, the electronic component is connected electrically with the circuit of the basic module to enable operation of the basic module or a mode of operation of the basic module.

20. The housing back cover of claim 19, said electronic component comprising a battery, a wireless transceiver, a charging circuit for charging a battery in the basic module, or a controller that controls said mode of operation.

21. The housing back cover of claim 18, said attachment portion attaching the back cover to the basic module at a location away from all edges of the back cover.

22. The housing cover of claim 18, said at least one hinge located away from all edges of the back cover, wherein when the front cover is in a horizontal position and the basic module rotated about said at least one hinge away from the front cover to an open position, the display panel is supported by the front cover wherein the front cover serves as a stand for holding the basic module with the display panel in an upright position.

23. The housing cover of claim 22, said front cover having a surface that faces said display panel and that has ridges thereon, said ridges separated by valleys that define positions for holding an edge of the basic module, to enable the display panel to be set at different upright positions at different angles to a vertical plane.

24. The housing cover of claim 22, said front cover having a surface that faces said display panel and that has a keyboard thereon, so that when the basic module is rotated about said at least one hinge away from the front cover to an open position and the front cover is in a horizontal position, the display panel is supported by the front cover and the keyboard is exposed and becomes available to the user for performing input functions.

25. The housing cover of claim 24, said surface of the front cover that faces said display panel has a ridge thereon that define a position for holding an edge of the basic module, to enable the display panel to be set at an upright position.

26. The housing cover of claim 18, said at least one mechanical hinge located at or near an edge of the back cover, so that when the front cover is rotated about said at least one hinge away from the display panel and the front cover is in a horizontal position, the display panel in an upright position.

27. The housing cover of claim 26, said front cover having a surface that faces said display panel and that has a keyboard thereon, so that when the basic module is rotated about said at least one hinge away from the front cover to an open position and the front cover is in a horizontal position, the display panel is supported by said at least one hinge and the front cover and the keyboard is exposed and becomes available to the user for performing input functions.
